(19) United States
(12) Patent Application Publication
(10) Pub. No.: US 2024/0123330 A1
(43) Pub. Date: Apr. 18, 2024

(54) APPARATUS FOR INTERACTION WITH VIRTUAL REALITY CONTENT

(71) Applicant: William WARREN, Camberwell (GB)

(72) Inventor: William WARREN, Camberwell (GB)

(21) Appl. No.: 18/277,451

(22) PCT Filed: Feb. 16, 2022
(86) PCT No.: PCT/IB2022/051390

§ 371 Date: Aug. 16, 2023

(30) Foreign Application Priority Data
Feb. 19, 2021 (GB) 2102382.5

(51) Int. Cl. A63F 13/212; A63F 13/245; A63F 13/285; A63F 13/90

(52) U.S. Cl. CPC A63F 13/212; A63F 13/245; A63F 13/285; A63F 13/90

(57) ABSTRACT

Aspects and embodiments of the present invention include an apparatus, including a body suit, for providing improved interactions with media content, particularly interactive digital content. The body suit is rotatable around a base and includes one or more of knee, hip and elbow joints that can be driven by motors, or manually. Furthermore, one or more of the knee, hip and elbow can apply resistance to motion by way of braking means. The motors and braking means of aspects and embodiments of the invention, as well as force feedback attachments, provide a sense of realism through improved interaction with interactive digital content. In addition, real world movements of the body suit can be interpreted into digital interactions within an interactive digital content environment.

### FIELD

Aspects of the present invention relate to apparatus for use in conjunction with compatible media content, particularly virtual reality content.

### BACKGROUND

Virtual reality, as well as augmented reality and extended reality, content provides an immersive experience for users engaging with a suitable delivery device. In most cases, a user would wear a headset that receives content from a computer or games console. (Most new headsets have the processing power built into the headset). The user interacts with a pair of hand controllers to control an in-content avatar or object. The user's interactions with the hand controllers are interpreted into digital movement of the person and/or object and this movement, and also interaction with other in-content person's and/or objects is demonstrated for display (audio and visual) to the user through the headset.

While virtual reality content is widely considered to be far more immersive than content that is generated for display on a conventional display device, i.e., a television or monitor, the user's experience is somewhat limited to visual and aural immersion, in most applications.

Efforts have been made to improve user's virtual experience. For example, treadmill devices that allow a user to walk in any direction within content have been developed. In one such example, a treadmill platform is rotatably mounted on a base. As a user rotates their body, the treadmill platform rotates relative to the base such that the user can walk in any direction within the content while always walking in a forward's direction on the treadmill. These treadmill devices are limited to navigation only. They help users move freely.

In another example, smart sensors and actuators can be embedded in clothing to both accurately measure a user's movement and impart haptic feedback to the user through the clothing. For example, if a user is shot in a game, the impact can be felt through application of feedback to the affected body part.

While the hardware available today undoubtedly can provide a satisfactory virtual experience to users, the type of experience available is still limited to basic motion and haptic feedback and the visual and aural senses.

Aspects of the present invention seek to provide a more encompassing and immersive virtual experience.

### SUMMARY

The body suit of the present invention is configured for use in an existing system that delivers computer generated virtual reality content to a user. The body suit includes an interactive sensory suit and a base. The base imparts rotational motion to the body suit. Embodiments of the body suit also comprise attachments for receiving the user's arms and legs and a spine for supporting the user when in a prone or laid down orientation. The body suit also comprises of a saddle, or seat to support the user when in a seated orientation. In one embodiment, the base houses a motor configured to selectively drive rotation of the support member relative to the base.

The body suit is intended for use as a peripheral device that receives instructions from a computer hosting a virtual reality content. The body suit uses the instructions received from the computer to generate physical sensations of being in the virtual reality environment. For example, if the user is walking through water in the virtual reality environment, the increased effort of walking through water can be imparted to the user through motors or brakes configured to provide resistance to the legs of the body suit as the user attempts to undertake a walking motion. Similarly, if the user is picking up a heavy object in the virtual reality environment, the weight of the object can be simulated by using a motor or brake associated with one, or both, arm(s) to require the user to impart more force to the arm(s) in order to move. The motors and/or brakes are configured to respond in real time to changes in the virtual reality environment.

The body suit comprises a plurality of sensors and actuators that are each controlled by a processor. The processor provides two-way communication from/to a computing device hosting the virtual reality environment. In simple terms, the processor receives data representing interaction of a character within the virtual reality environment. This data is interpreted into force feedback through actuation of the motors and/or brakes. The processor also collects data from the sensors to represent physical movement, i.e., force applied, direction and position, of the user in the real world The processor collects data from the sensor as to the position, force and direction of the user's actual movements in the real world and feeds this back into the computer so that an accurate representation of the user's position and physical state can be displayed in the virtual reality content. This sensor data is transmitted to the computer hosting the virtual reality environment. The computer translates the sensor data representing the physical movement of the user in the real world to motion of a character within the virtual reality environment.

While aspects of the present invention are described by way of reference to virtual reality content, it will be appreciated that the term “virtual reality” can be replaced with augmented reality, extended reality, or any future term used to describe immersive content without affecting the scope of the claimed invention.

Apparatus according to one aspect of the invention comprises a body suit configured to receive one or more parts of a user's anatomy, and a base, wherein the body portion is supported by and spaced apart from the base by a support member and is configured to rotate relative to the base.

Most users of virtual reality content simply use a virtual reality headset and hand controllers to immerse themselves in the content. When wearing a virtual reality headset, users cannot see the real-world environment around them. This makes it impractical to use real world movement as a movement control input for the virtual reality content without use of a dedicated space. While many headsets generate their own position, full body position is only possible in the prior art with an external motion capture device and trackers worn by the user. In general, most prior art VR headsets and peripheral devices are only able to track location, and direction of travel of head and hands, but not the actual position or orientation of a user's limbs. Treadmills provide a solution that enables a walking motion to be translated into an input for virtual reality content. While this is undoubtedly an improvement over using a hand-held controller for providing input for the virtual reality navigation, there are many other types of motion that a user may wish to use for different types of virtual reality content. For example, if swimming in the virtual reality content, the user may wish to take a prone position and simulate a swimming motion using their arms and legs. If participating in a virtual fight, the user may wish to be able to perform a kicking action. When riding a virtual skateboard, the user may wish to lean, jump and twist to provide a life like experience. These motions, and many more, are not possible using a 360-degree treadmill. As such, aspects of the present invention provide a much-improved user experience when using virtual reality content.

In one embodiment, the body portion comprises a pair of legs, each leg comprising an upper leg part and a lower leg part connected by an articulated knee joint, wherein the knee joint comprises a housing forming part of one of the upper or lower leg parts and a plate forming part of the other of the upper or leg parts, and wherein the knee joint is configured to restrain movement of the leg to a single degree of freedom and selectively resist movement of the lower leg part relative to the upper leg part. The housing may be a brake calliper, and the plate may be a brake disc. The knee joint may further comprise a pair of brake pads that can be selectively applied to resist movement of the lower leg part relative to the upper leg part. The knee joint may further comprise a motor that is configured to drive the knee joint to move the lower leg part relative to the upper leg part between a first and second position.

Existing feedback devices for virtual reality, or video game, content are generally limited to applying vibration of differing characteristics to the user by way of a motor, or other vibrating actuator. This can provide a degree of realism in terms of simulating touch, for example. The present invention goes further and permits the user to experience a much wider range of feedback that is dependent on different content parameters. For example, if a user is attempting to run or walk through mud or water in the content, this can be simulated by applying a resistance force to the knee joint by way of a dedicated brake or through motor resistance. The more viscous the in-game substance, the greater the applied resistance. Similarly, if the user is running down a hill in the game, no resistance will be applied, and as will be explained further below, the knee joint may be driven by a motor to simulate the gravitational effect of running down a hill. Furthermore, a baseline resistance may be applied during periods where the user is simply walking through an in-game environment. This provides flexibility to increase or decrease resistance depending on variations of surface and environment in the game. This can be illustrated by a game where a user may be walking. The terrain in the game may be undulating and it would be desirable to simulate an increase in effort when walking up a hill and the reduction in effort when walking down a hill. This can be achieved by applying a variable braking force to the knee joint in response to telemetry data received from the game. There are many examples in which the ability to variably apply a braking or acceleration force to a knee joint would provide an improved user interaction with and experience of virtual reality, or video game, content.

In one embodiment, the body portion comprises a pair of arms, each arm comprising an upper arm part and a lower arm part connected by an elbow joint, wherein the elbow joint comprises a bearing surface that is configured to permit rotation of the lower arm part relative to the upper arm part between a first position in which the arm is fully extended, to a second position. The bearing surface may comprise a primary bearing surface defined by a projection forming part of one of the lower arm part or upper arm part and a secondary bearing surface defined by the other of the lower arm part or upper part. The primary bearing surface may be moveable relative to the secondary bearing surface between the first position and the second position with further movement restrained by a first stop that engages the projection when the lower arm part is in the first position and a second stop that engages the projection when the lower arm part is in the second position. The elbow joint may further comprise a motor that is configured to drive the elbow joint to move the lower arm part relative to the upper arm part between the first and second positions. The elbow joint may further comprise a brake calliper forming part of one of the upper arm part or lower arm part and a brake disc forming part of the other of the upper arm part or lower arm part.

Existing feedback devices are generally limited to delivering force feedback to a user in a limited range of circumstances, i.e., driving or pilot simulation. The present invention provides improved interaction and engagement with virtual reality content by applying a resistance and/or power to movement of a user's arms. This is achieved by way of braking means or a motor in the limbs and hips or rotational position of the support member. In a shooter game, the user is presented with weapons of different types. For example, the user may select from a rifle, a rocket launcher or a heavy machine gun. In the real world, these types of weapons would vary significantly in weight. The invention can simulate the weight of different weapons by imparting a braking resistance through braking means or a motor to make movement of the user's arms easier or harder depending on the weight of the currently selected weapon. In another example, the user may be permitted to move their arms freely when simulating movement in the open air whereas resistance may be imparted to the user's arms if the user is attempting to move their arms in water in the video game. In yet another example, if the user is attempting to punch objects in the video game, the braking means or motor may act to rapidly stop forward motion of the user's arms to simulate the user's first impacting with an object. There are many examples in which the ability to variably apply a braking or acceleration force to an elbow joint would provide an improved user interaction with and experience of virtual reality, or video game, content.

In one embodiment, the body portion further comprises a spine configured from a plurality of vertebrae, wherein each of the plurality of vertebrae is mounted on a flexible skin, and an attachment means for attaching the body suit to a user's body, wherein the spine is configured to deform in compliance with the user's movement. The spine may further comprise a connection member between adjacent vertebrae, wherein the connection members provide resistance against compression and lateral deformation when the spine is in an upright condition and provide a hinged connection between adjacent vertebrae to facilitate forwards and limited backwards deformation of the spine. The vertebra at the top of the stack may have a width greater than each other vertebra in the stack, the vertebra at the bottom of the stack may have a width less than each other vertebra in the stack, and each other vertebra in the stack may have a width that is progressively less than the vertebra above it. The spine may further comprise tendons for each vertebrae passing latitudally across each of the vertebrae linking it to the vertebrae below. The flexible material may be formed from a non-elastic material. The non-elastic material may be leather.

The spine of the body suit of aspects of the invention advantageously supports the weight of the user in a range of different positions. The user is able to move between a range of position from backward reclined to forward prone. The spine is able to move compliantly to compliment and support the user's own spine. The configuration of the vertebrae and connectors prohibits backwards movement beyond a pre-determined limit. This limit is set by the connectors themselves which effectively sit atop one another to create a stop that prevents further backward movement once the pre-determined limit is reached. Furthermore, the flexible skin is positioned inside the vertebrae and connectors and is formed from a non-elastic material, i.e., leather, that further limits the movement of the spine in forwards and backwards directions. This allows the user to confidently position their body in any position necessary to fully immerse themselves in a video game. For example, in the backwards recline position the user can simulate weightlessness with their feet off the floor and their body fully support by the body support. In a forward prone position, the user is able to simulate situations such as being in the prone position in a shooter game or swimming in an ocean explorer game. The spine construction provides a larger vertebra at the head end of the spine than at the bottom end of the spine. The larger vertebra at the head end of the spine supports the width of the user's shoulders and, together with the head rest, supports the weight of the user's upper body when in the backward position. The cross vertebrae tendons are elasticated to provided a degree of resistance against forward movement. This serves two purposes: i) the user cannot simply fall forwards; they have to make a deliberate and conscious effort to overcome the resistance of the tendons to move into a forwards position; and ii) the tendons provide a biasing force towards the upright position of the spine to make it simple for a user to revert to a reference position and to come out of the forward prone position.

In one embodiment, a pelvis mechanism joins the torso to the legs, wherein the pelvis mechanism comprises an anchor and a floating frame joined by a pair of connection members, wherein each connection member is able to pivot relative to both the anchor and floating frame such that the floating frame is moveable into a plurality of positions along an arc relative to the anchor. Each connection member stands in parallel, slightly closer together at the top than at the bottom, in line front to back. This creates an arc of movement for the pelvis that is stopped at the front extreme by the rear connecting member leaning forward to make contact with the front connecting member, or at the extreme rear position, by the front connecting member leaning back to make contact with the rear connecting member.

The pelvis mechanism of aspects of the invention provides front and rear pivots both at the floating frame end of the connection members and the anchor end of the connection members. As the user moves their torso and femur, and moves positions between backward recline and forward prone, the double pivot nature of the pelvis mechanism provides a much greater range of movement than would be possible with a conventional hip joint arrangement. As will be discussed further below, aspects of the present invention also include a pair of hip joints and the pelvis mechanism supplements movement provided by the hip joints. This combination of anatomical joints advantageously allows a much greater range of motion than is possible by the human body alone and allows the user to take up nearly any position that they may wish to assume to immerse themselves in video game content. The pelvis also functions to reposition the user's body weight in front or behind the support member. When leaning forward prone the user's weight is moved behind the pole, when leaning backward the user's weight is shifted in front of the support member.

In one embodiment, the body suit further comprises at least one transducer speaker.

The transducer speaker applies haptic sound feedback through vibration to the user's body. By positioning at least one transducer speaker in or on the body suit, sound output from the virtual reality content is converted into vibration feedback and directly experienced by the user.

For example, a transducer speaker incorporated into the pelvis of the body suit may simulate the effect of feeling the breathing of a horse you are riding or the throb of a motorcycle engine. A transducer speaker incorporated into the base may simulate an earthquake. A transducer speaker incorporated into the arms, legs of the body suit may simulate the effect of something touching the users limbs.

In one embodiment, the body portion further comprises a pair of hips, each hip comprising an anchor positioned at opposing sides of the pelvis floating frame and fixed thereto and a leg support member that is moveable in a forwards and backwards motion relative to the pelvis floating frame. The body portion may further comprise a brace connecting the support member of the hip and the knee. Each hip may be driven by a respective brake/motor/actuator to any intermediate position between first and second positions.

Hips as used in aspects of the bodysuit of the present invention are located in a position that is anatomically similar to the natural position of the user's hip. The brace between the hip and the knee effectively acts as a femur to provide a fixed relationship between the hip and the knee in order to provide the maximum amount of freedom of movement whilst retaining maximum control of such movement. Use of a brake/motor to effect/drive the hips enables simulation of walking or running in different terrains and on different surfaces. Furthermore, the combination of the double pivoted pelvis, as described above, and the hips of the bodysuit, provides highly variable positioning of the user's core and upper legs. Movement of the pelvis, in combination with the hips enables the user to deliver greater force to move the hips when restrained by the motor and/or braking means.

In one embodiment, the apparatus further comprises a force feedback attachment that is moveable between a first position behind the body suit and a second position in front of the body suit, wherein the force feedback attachment? is configured to impart movement and vibration feedback into the body suit when in the first position and to be used as input device for driving game content when in the second position. The input device of the force feedback attachment may house any control device for controlling objects within video game content.

The force feedback attachment illustrated in the figures serves two purposes. Firstly, when located behind the user, the force feedback attachment acts as a support for the spine and limits backwards movement of the user when entering a recline position. Actuators within the force feedback attachment is used to impart vibration and rotational movement characteristics directly to the user through contact of the spine of the bodysuit with an input wheel. Secondly, when located in front of the user, the force feedback attachment acts as input device for video game content. In the illustrated embodiment, the force feedback attachment comprises a driving rig including a steering wheel and pedals. The way in which the force feedback attachment is configured is advantageous as it allows the user to stow it out of the way when not needed but still benefit from elements of the functionality of the force feedback attachment. When the force feedback attachment is needed for use, the user is able to simply release a lock located under the double pivot, above the support member that restrains the angular position of the force feedback attachment relative to the body suit and rotate the force feedback attachment around the support member to in front of the body suit. The lock is then reapplied to again (automatic catch closes) restraining the angular position of the force feedback attachment relative to the bodysuit.

In one embodiment, the apparatus further comprises a controller for: i) receiving an output from video game content and actuating one or more of the knees, elbows, hips or force feedback attachment in correlation with an action from within the video content; and ii) determining a position, motion, measuring applied force (load cell) or other action of one or more of the knees, elbows, hips or force feedback attachment and instructing an object from within the video game content to take a pre-determined action.

The controller acts as a gateway between the bodysuit and an external the media device, i.e., a personal computer, games console, media guidance player, smart phone, tablet, or the like. It provides two-way communication between the bodysuit and the external media device to provide synchronicity between the position, stance, orientation or configuration of an in-game character or object and the corresponding position, stance, orientation or configuration of the bodysuit in the real world. The controller provides feedback and automated joint motion to the bodysuit to generate an unparalleled sense of realism when the user dons the bodysuit and a virtual reality headset. This is achieved through monitoring of the position of one or more of a knee joint, elbow joint or hip of the bodysuit and controlling both the aforementioned joints of the bodysuit and the in-game character or object in parallel to achieve the desired synchronicity.

In one embodiment the controller may be configured to: (a) receive an input from a media device representative of an instruction to move a knee joint, elbow joint or hip from a first position to a second position; (b) retrieve from a database a potentiometer value for the second position; compare the potentiometer value for the second position with a range of safe potentiometer values; (c) if the potentiometer value for the second position lies within the range of safe potentiometer values, instruct a motor to move the knee joint, elbow joint or hip from the first position to the second position; (d) and if the potentiometer value for the second position is outside of the range of safe potentiometer values, either instruct a motor to move the knee joint, elbow joint or hip to a third position that corresponds to a potentiometer value that lies within the range of safe potentiometer values, or take no action.

The controller understands the instantaneous position of each joint of the bodysuit. This is important to ensure that any instruction given to a motor to drive an associated joint to a position synchronous with the position of a corresponding joint of an in-game person or object would result in movement of the joint to a position within a pre-determined acceptable range. As a default, the controller may be set to only permit movement of each joint within quite a narrow range of movement. This is needed to ensure that a user's limbs are not moved beyond their natural range of motion thus potentially causing discomfort and/or injury. The user may manually adjust the maximum range of motion or force of each joint and/or the controller may provide an opportunity for the user to automatically adjust the maximum range of motion of each joint through conducting a range configuration technique. For example, prior to use, or at any time in the future, the user may be prompted to, or may select to, undertake a configuration technique. The controller may disengage the motor from an associated joint or may impart a constant resistance to the associated joint in order that the user can move the joint between a range of positions and undertake a range of motions and/or actions. Based on the outcome of the configuration test, the controller may set a new range of maximum motion. This can be played back to the user upon conclusion of the configuration technique, and the user may accept or reject the new maximum range of motion. Each knee and elbow may comprise a loadcell that measures the amount of force being applied to the joint. Each knee and elbow may not be extended beyond a pre-determined position when the user straightens their limbs. This may be provided for by stops built into the first and second elbow parts and first and second knee parts.

In one embodiment, the body suit is selectively moveable between a reclined position in which the user rotates the hip of the body suit forwards to a first position and a face down position in which the user rotates the hip of the body suit backwards to a second position. Movement of the body suit between the first position and the second position may be driven by a motor operated by controller and the body suit can be selectively moved to an intermediate position between the first position and the second position.

Movement of the body suit to a range of position between backward incline and forward prone enables the user to enter and maintain a wide range of positions to accurately replicate the movements of an in-game character. For example, the user may easily move between a prone position for snorkeling to a seated position for driving a 4×4 vehicle in shooter games such as Call of Duty @. In adventure games such as Tomb Raider @, the user may easily move from a running position to a forward prone position to replicate a swimming action. There are a wide range of positions that the user can take using the bodysuit of aspects of the present invention to generate a sense of realism when immersing oneself in virtual reality content.

In one embodiment, the apparatus further comprises at least one position sensor associated with at least one of the knee joint, elbow joint, hip or force feedback attachment of the body suit, wherein each position sensor is configured to determine the position of a respective knee, elbow, hip or force feedback attachment relative to a predetermined reference position. The position sensor may be a potentiometer.

Use of a potentiometer to determine the position of a knee joint, elbow joint, hip, or the force feedback attachment provides a simple way to accurately and quickly understand the position of each joint of the bodysuit. Each position of a joint is known from the output resistance of the associated potentiometer. By measuring the instantaneous voltage of the potentiometer, the angular position of the joint is easily determined. This is advantageous in providing synchronicity between the joints of the bodysuit and the position, stance, configuration etc, of an in-game person or object.

### DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 illustrates an isometric view of apparatus according to aspects and embodiments of the present invention.

FIG. 2 illustrates a side view of apparatus according to aspects and embodiments of the present invention.

FIG. 3 illustrates an exploded view of an embodiment of the base of the present invention.

FIG. 4A illustrates a pelvis of a body suit in a first position as used in aspects and embodiments of the present invention.

FIG. 4B shows the pelvis of FIG. 3A in a second position.

FIG. 4C shows the pelvis of FIG. 3A in an intermediate position.

FIG. 5A illustrates a first view of a hip of a body suit as used in aspects and embodiments of the present invention.

FIG. 5B illustrates a brake disc of the hip of FIG. 5A.

FIGS. 6A and 6B illustrate a knee of a body suit as used in aspects and embodiments of the present invention.

FIGS. 7A and 7B illustrate an elbow of a body suit as used in aspects and embodiments of the present invention.

FIG. 8 illustrates a spine of a body suit as used in aspects and embodiments of the present invention.

FIGS. 9A and 9B illustrate a force feedback attachment as used in aspects and embodiments of the present invention.

FIG. 9C illustrates a locking mechanism for the force feedback attachment.

FIG. 10 is a block diagram of an embodiment of the disclosure.

FIG. 11 illustrates a flow chart showing a first implementation of safety protocols to prevent movement of body suit joints beyond safe limits.

FIG. 12 illustrates a flow chart showing a second implementation of safety protocols to prevent movement of body suit joints beyond safe limits.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

### DESCRIPTION

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

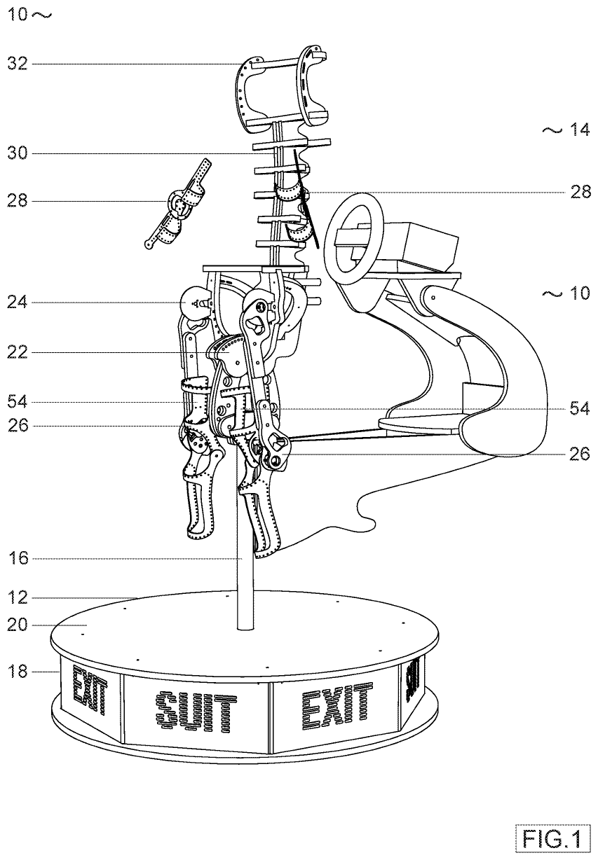

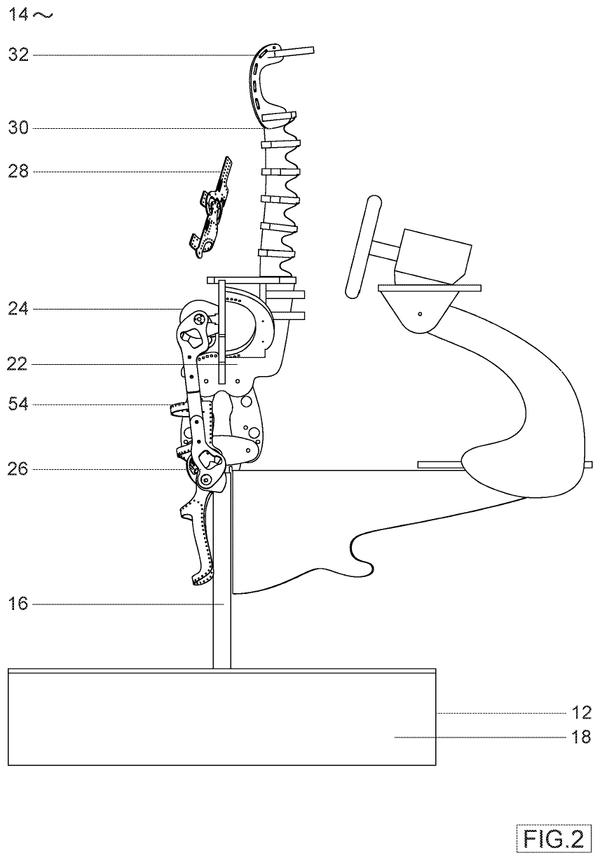

Detailed reference will now be made to one or more potential embodiments of the disclosure, which are illustrated in the figures. As shown in FIGS. 1 and 2, apparatus (10) according to embodiments of the invention comprises a base (12) and a body suit (14). The body suit (14) is connected to, and spaced apart from, the base (12) by way of a support member (16), or pole. The support member (16) is fixedly attached to the body suit (14), as described in more detail below, and is rotatably attached to the base (12).

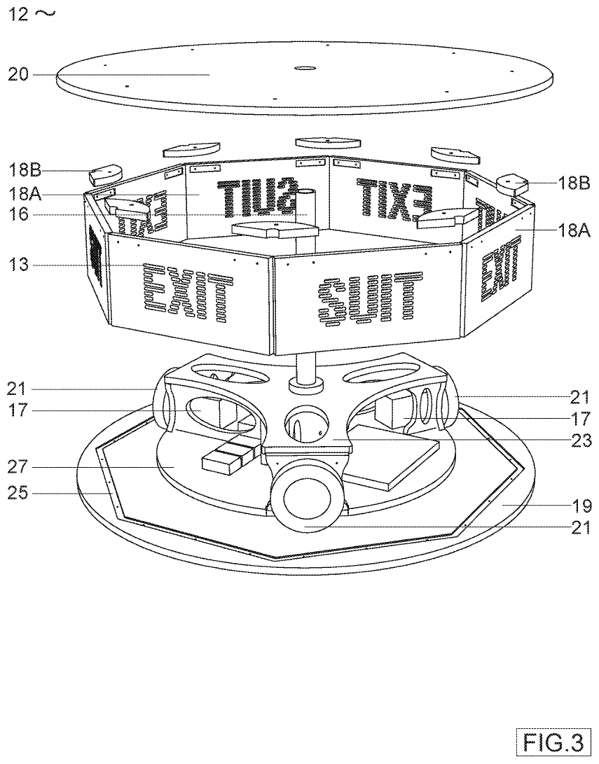

In some embodiments, as shown in more detail in FIG. 3, the base (12) may incorporate a motor that is configured to drive rotation of the support member (16) relative to the base (12). In other embodiments, the support member is rotatable relative to the base (12) by engagement of a user's feet with the base (12) when the user is wearing the body suit (14). As illustrated, the base (12) may comprise a perimeter wall (18), a bottom surface (19) and a top surface (20).

The perimeter wall (18) is illustrated in FIG. 3 as being octagonal in shape. While this is advantageous in terms of strength of construction, it will be appreciated that the perimeter wall (18) may be any other suitable shape. The perimeter wall (18) may be constructed from separate panels (18a) which are joined by at least one angle bracket (18b) between each pair of adjacent panels (18a). The angle brackets (18b) are positioned towards the top of the perimeter wall (18) and comprise a planar upper surface upon which the top surface (20) of the base (12) is supported. Each angle bracket (18b) is bolted to two panels (18a) to provide a mechanical connection therebetween. The top surface (20) is screwed or bolted to each angle bracket (18b). In addition, the underside of the the top surface (20) comprises a groove (not shown) for receiving the top of the perimeter wall (18). The bottom of the perimeter wall (18) is screwed or bolted to the top of the bottom surface (19) and sits within a groove (25) therein.

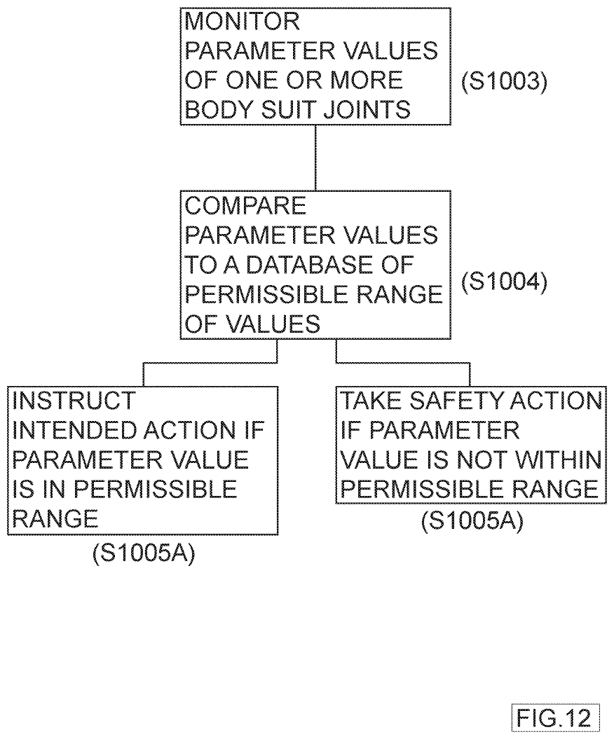

A void may be defined within the perimeter wall (18) for receiving at least one motor (17) and/or a controller (100)—see FIG. 12. The bottom surface (19) of the base (12) may have a solid surface, i.e., akin to the top surface (20). Each of the perimeter wall (18), top surface (20) and bottom surface (19) may be provided with vents (13). The bottom surface may be supported by fixed feet, casters or rollers, for example. The top surface may be supported by the perimeter wall and may be secured in place by a “snap-fit” connection or by way of one or more fixings. The bottom surface 19 defines a contact surface for one or more rollers (21) that are driven by one or more of the motors (17). Each roller is mounted to a central frame (23) that in turn supports the support member (16). The central frame (23) comprises a raised pedestal (27) and a support structure defining a box for housing the motors (17), a computer device hosting the virtual reality content, and other electronic components and control circuitry. In use, the central frame (23) and support member (16) rotate relative to the perimeter wall (18), bottom surface (19) and top surface (20) of the base (12).

The support member (16) may be hollow to permit passage of electrical, pneumatic or hydraulic cables therethrough in order to connect components contained within the base (12) with actuators and/or sensors attached to the body suit (14). Rotating couplings, contact brushes, slip rings, or the like, may be utilised to accommodate the rotation of the support member (16) and body suit (14) relative to the base (12). The support member (16) may be defined by a hollow tube formed from stainless steel, or any other suitable material, i.e., aluminium or composite, with the physical properties capable to support the weight of the body suit (14) and a user.

The body suit (14) comprises a pelvis (22), pair of hips (24), pair of knees (26), pair of elbows (28), a spine (30) and headrest (32), each of which is described further below.

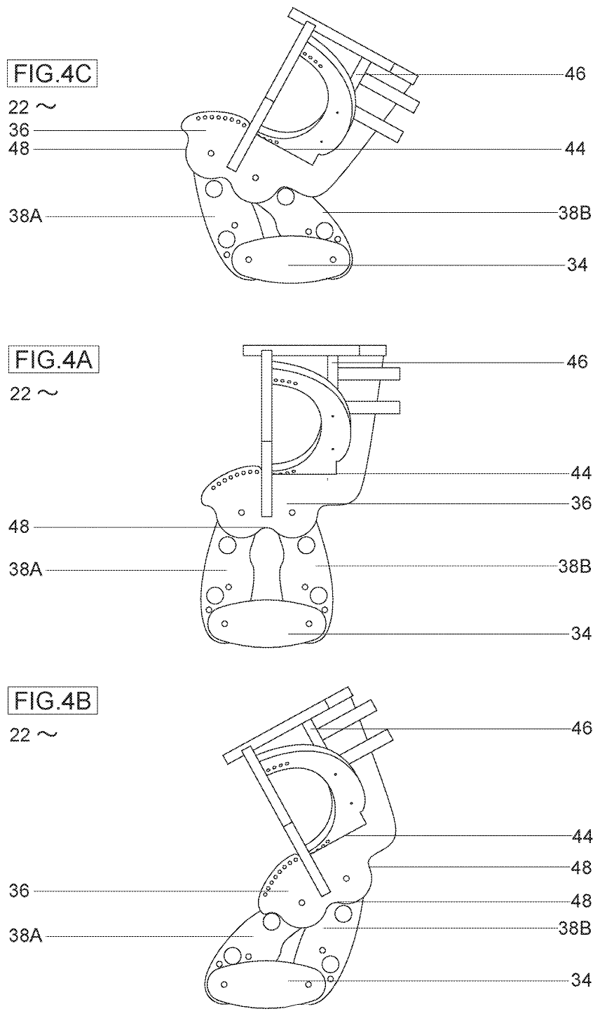

As shown in FIGS. 4A-C, the pelvis (22) comprises an anchor (34) which serves two purposes. Firstly, the anchor (34) secures the body suit (14) to the support member (16). Secondly, the anchor (34) provides an attachment point for a floating frame (36). A pair of connection members (38) connect the anchor (34) to the floating frame (36). Each connection member (38) comprises a first end that pivotally connects to the anchor (34) and a second end that pivotally connects to the floating frame (36). The connection members (38), anchor (34) and floating frame (36) define a quadrilateral between them. The connection members (38) may be bound together by one or more elastic straps or bungee cords. This provides a natural bias into an upright position (see FIG. 4A) and some resistance against movement towards the forwards (see FIG. 4B) and backwards (see FIG. 4C) positions of the body suit (14).

The floating frame (36) comprises a saddle (44) for supporting a user's bottom. The saddle (44) has a seating ledge, softened by a woven elastic compound curve and a rear supporting surface (46) for supporting the user's lower back. In use, the floating frame (36) is moveable between a first, forward position and a second, rearward position. In one embodiment, the first and second positions are limited to 28 degrees offset from a vertical axis of the body suit (14). The forwards and backwards movement of the body suit (14), taking the pelvis (22) as a reference point, is limited by the maximum extent of movement of the connection members (38) relative to the anchor (34) and the floating frame (36) relative to the connection members (36).

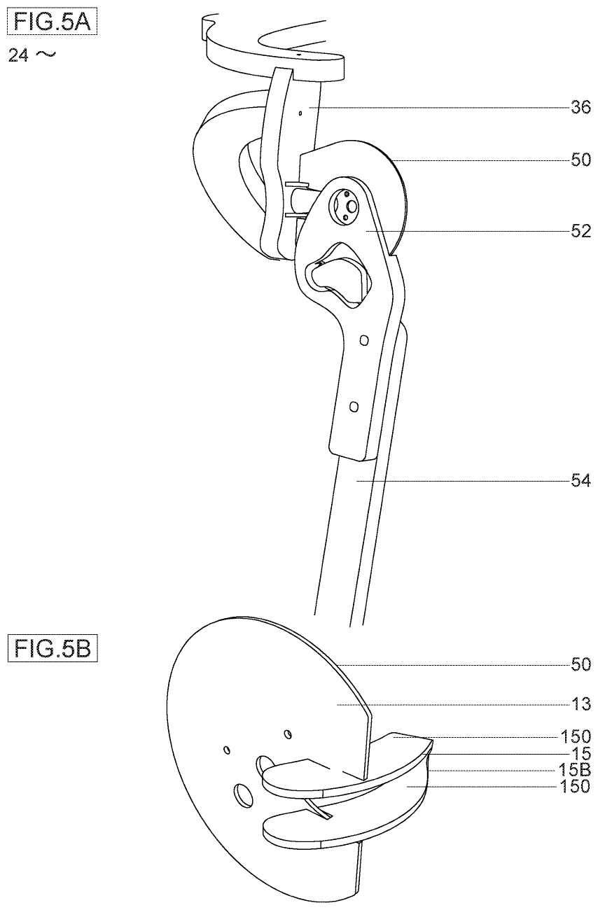

As shown in FIG. 5A, the hips (24) of the body suit (14) comprise respective anchors (50) fixed to opposing sides of the floating frame (36) of the pelvis (22). The anchors (50) contain ball and socket joints that each comprise one of an outward facing projection/ball or an aperture/socket. A hip support plate (52) comprises the other of the projection/ball or aperture/socket. The hip support plate (52) comprises a first end that together with the anchor (50) defines a bearing surface and a second end that mounts a brace (54) for connecting a hip (20) to a knee (26). Together a hip (24) and knee (26) define the supporting structure for receiving a user's leg. A flexible material may be provided that is configured to surround parts of the supporting structure and to receive and further support a leg of the user. The brace (54) restrains movement of the user's leg through the hip (24) in a single direction of freedom, i.e., forwards and backwards relative to the floating frame (36). In some embodiments, a motor is configured to drive the hip support plate (52) relative to the anchor (50). Forwards and backwards motion of the hip support plate (52) is restrained by a first stop and a second stop. The first stop engages the anchor (50) when the hip support plate (52) reaches a first position representative of the limit of its forward motion. The second stop engages the anchor (50) when the hip support plate (52) reaches a second position representative of the limit of its backward motion.

In some embodiments, braking means may be provided to apply a braking force that makes movement of the hip (24) more difficult for the user. As discussed further below in connection with elbows (28) of embodiments of the invention, the braking means for the hip (24) may be provided by a disc brake (13) with a retaining strip arrangement (15), as shown in FIG. 5B. The retaining strip (15) is orientated transverse to the disc brake (13) and is positioned within an arcuate cutout through the disc brake (13). The retaining strip (15) is defined by a pair of spaced apart plates (15a) that are joined at one end by a bridge (15b). The bridge (15b) acts as a stop to limit the extent of outwards movement of the user's leg. This is achieved by a part of the ball and socket joint being retained between the pair of spaced apart legs (15a) of the retaining strip (15) and engaging the bridge (15b) when at the limit of permissible outward movement of the user's leg. The retaining strip's (15) main job is to keep the disc brake (13) in a fixed position whilst allowing the ball and socket to move freely. At any leg angle, the brake disk (13) is fixed ready for if resistance is applied. The position of the user's leg is further limited by fixed permissible rotation around an axis defined by a cut-out (13a) through the brake disc and the first and second stops described above.

The disc brake may be actuated by a conventional cable, electronically or by way of hydraulics, for example. The braking means may also comprise an electromagnetic brake, or any other suitable braking device that the skilled person may envision.

Each hip (24) may comprise a potentiometer configured to measure the angle of the hip (24). This is achieved by assigning a known voltage to a data field that is associated with an angular position of the hip relative to a reference position. The measured voltage varies depending on the angular position of the hip (24) and is compared to the data fields to identify the angle of the hip (24) based on the voltage measured by the potentiometer. While the present invention is described by way of reference to a potentiometer, the skilled person will appreciate that any other known means of measuring the angle of a joint, i.e., a camera-based system, may be utilised.

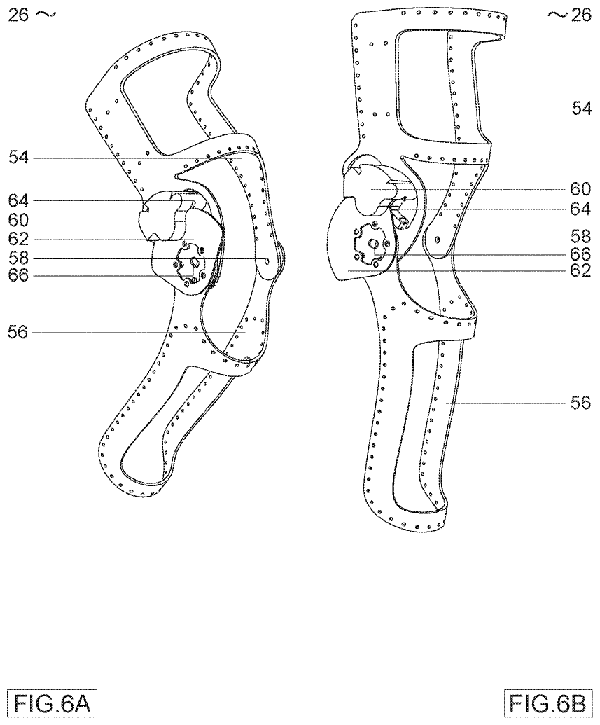

As shown in FIGS. 6A and 6B, a knee (26) of the body suit comprises an upper knee portion (54) and a lower knee portion (56) that are connected by a hinged joint (58). The upper knee part (54) supports a user's femur, and the lower knee part (56) supports the user's tibia and fibia. The knee (26) is open in the vicinity of the hinged joint (58) to allow the user's knee joint to move freely when using the body suit (14). The upper knee part (54) mounts a brake calliper (60). The lower knee part (56) mounts a brake disc (62). The brake calliper (60) includes a slot (64) within which part of the brake disc (62) is inserted. The brake calliper (60) further mounts a pair of brake pads (not shown). The brake pads can be selectively engaged and disengaged from the brake disc (62), in the manner described above, and varying levels of braking force can be applied to vary the force required to be imparted by the user to move the lower knee part (56) relative to the upper knee part (54). The brake disc (62) includes a mount (66) for receiving the end of the brace (54) opposite the hip (24). Movement of the lower knee portion (56) relative to the upper knee portion (54) is limited in the forwards and backwards directions by a stop forming part of the brace (54) that engages opposing sides of the brake disc (62) depending on whether the lower knee portion (56) is fully extended or moved to the limit of its backwards movement.

In use, a user performs a walking motion, the hip (24) and the knee (26) work together to provide an authentic walking experience. In the event that the user is walking through water, or sand, for example, in game, the brake pads can be applied to the brake disc (62) to provide resistance and a realistic walking sensation that replicates the in-game environment. FIG. 5A shows the knee (26) in an extended position. FIG. 5B shows the knee (26) positioned to the extent of its permissible backwards movement.

Each knee (26) comprises a potentiometer configured to measure the angle of the knee (26). This is achieved by assigning a known voltage to a data field that is associated with an angular position of the knee (26) relative to a reference position. The measured voltage varies depending on the angular position of the knee (26) and is compared to the data fields to identify the angle of the knee (26) based on the voltage measured by the potentiometer.

In addition to the braking means (60, 62) each knee (26) may also be provided with a motor to drive the knee joint (26) between various positions and/or to provide resistance to the user's leg movement.

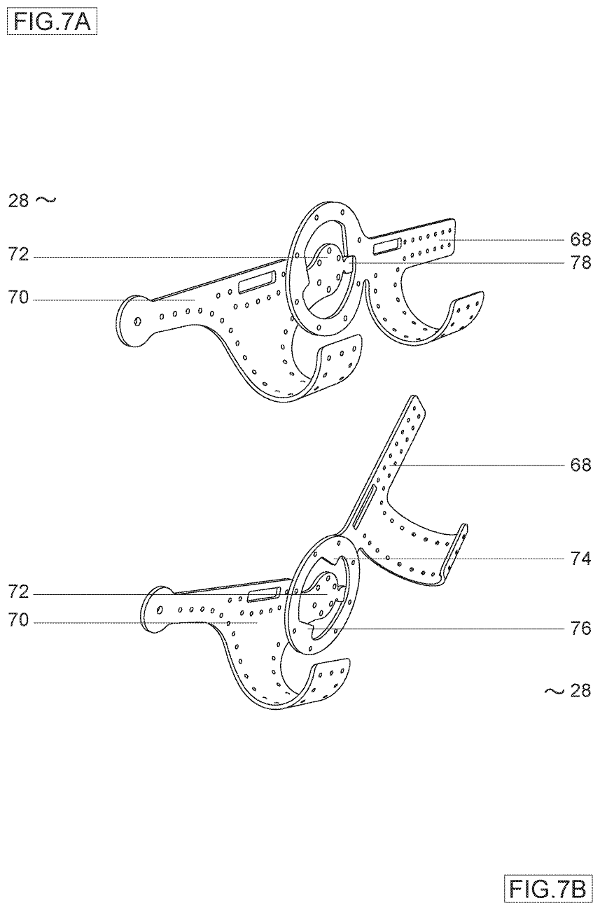

As shown in FIG. 7, an elbow (28) of the body suit (14) comprises an upper elbow part (68) and a lower elbow part (70) that are connected by a hinged joint (72). The upper elbow part (68) supports the user's humerus. The lower elbow part (70) supports the user's radius and ulna. The elbow (28) is open in the vicinity of the hinged joint (72) to allow the user's elbow joint to move freely when using the body suit (14). The upper elbow part (68) and lower elbow part (70) are connected by a motor which restricts movement of the lower elbow part (70) relative to the upper elbow part (68) in a single direction of freedom. Actuation of the motor causes the lower elbow part (70) to move relative to the upper elbow part (68) within a predefined range of motion. The motor provides resistance to movement to simulate lifting of a heavy load, pushing an object, swimming, for example. Movement of the lower elbow part (70) relative to the upper elbow part (68) is limited by way of first and second stops stop (74, 76) forming part of the upper elbow part (68) and a projection (78) forming part of the lower elbow part (72). When the lower elbow part (70) is fully extended relative to the upper elbow part (68), the projection (78) engages the stop (74). When lower elbow part (70) is moved backwards to the limit of its movement relative to the upper elbow part (68), the projection (78) engages the stop (76). The user's arm is supported by a flexible material surrounding the elbow (28).

Each elbow (28) may comprise a potentiometer configured to measure the angle of the elbow (28). This is achieved by assigning a known voltage to a data field that is associated with an angular position of the elbow (28) relative to a reference position. The measured voltage varies depending on the angular position of the elbow (28) and is compared to the data fields to identify the angle of the elbow (28) based on the voltage measured by the potentiometer. Alternatively, in an embodiment where an elbow (28) is motor driven, the motor may have position awareness to accurately determine the angle of the elbow (28).

In addition to the motor, each elbow (28) may also be provided with a disc brake. In such an embodiment, the upper elbow part (68) may mount a brake calliper and the lower elbow part (70) may mount a brake disc. The brake calliper includes a slot within which part of the brake disc is inserted. The brake calliper further mounts a pair of brake pads. The brake pads can be selectively engaged and disengaged from the brake disc and varying levels of braking force can be applied to vary the force required to be imparted by the user to move the lower elbow part (70) relative to the upper elbow part (68).

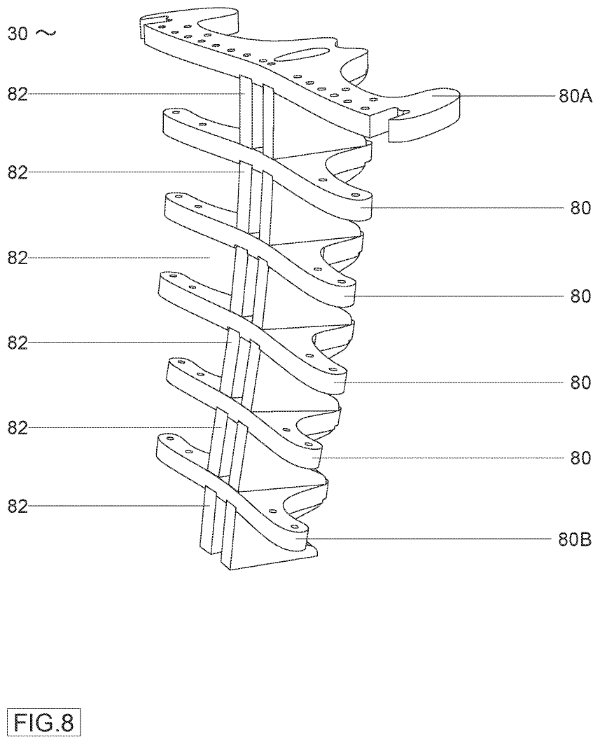

FIG. 8 shows a spine (30) that forms the rear of the body suit (14). The spine (30) is defined by a plurality of spaced apart vertebrae (80) and a connecting member (82) between each pair of vertebrae (80). The connecting member (82) provides a hinged joint flexible connection between all vertebrae. The spine (30) has a naturally slightly curved configuration when locked in an upright configuration to replicate the natural curvature of a human spine. The hinged connection between each vertebra (80) is provided by a flexible material, i.e., leather, to which each vertebra (80) is attached. As the user moves forwards and backwards, the flexible material complies with the change in body shape of the user's spine while the vertebrae (80) provide structure and support. When in an upright position, or a slightly reclined position the connecting members (82) are substantially aligned and stacked atop one another. This configuration prevents further backwards movement of the body suit (14). Sideways movement is also limited by the flexible material.

In the illustrated embodiment, the vertebra (80a) nearest the head end of the spine (30) has a greater width dimension than any other vertebra of the spine (30). The vertebra (80b) nearest the bottom end of the spine (30) has a lesser width dimension that any other vertebra (80) of the spine (30). The intermediate vertebrae decrease in width dimension from the top of the spine (30) to the bottom of the spine (30). The bottom two vertebrae (80) may have identical widths and may be shaped to curve the lower spine to create a lumber support. The third and fourth vertebrae (80) in the stack of vertebrae are wider and identical. The fifth and sixth vertebrae (80) in the stack of vertebrae are wider still. The four uppermost vertebrae (80) are angled to curve the spine (30) less than straight to create a shallow curved backrest.

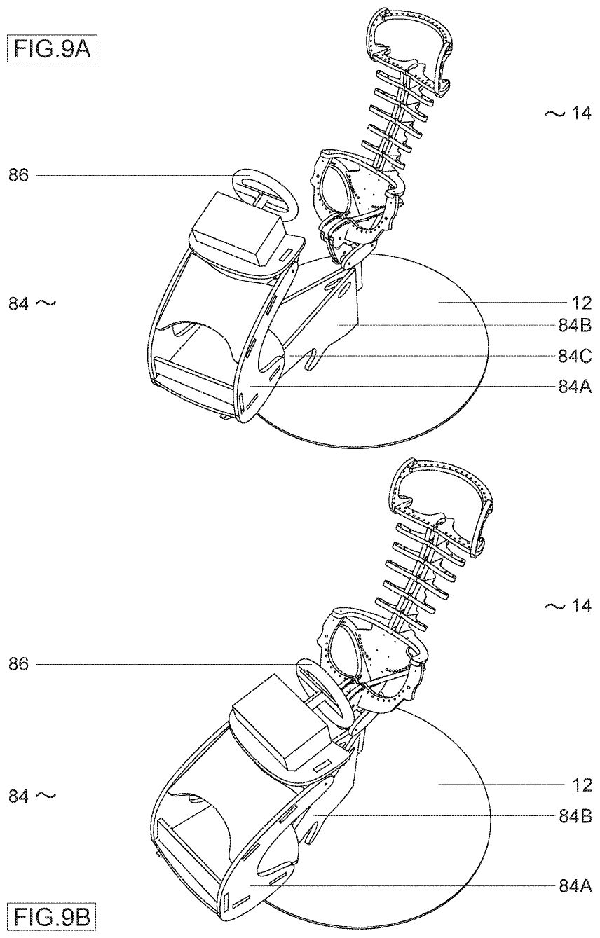

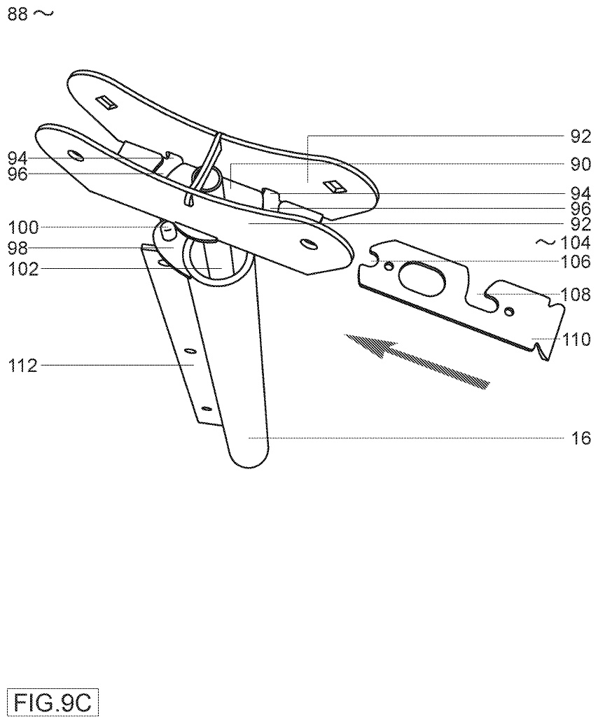

As shown in FIGS. 9A-9C, a force feedback attachment (84) may be provided. The force feedback attachment (84) is shown attached to the support member (16) and may be moved from a rear position (see FIG. 9A) in which the spine (30) and the user's shoulders can be supported and influenced by a force feedback actuator, and a front position (see FIG. 9B) in which the force feedback attachment (84) may be used as an input device for virtual reality content.

When in the rear position (see FIGS. 1-2), the force feedback attachment (84) is able to make contact with the spine (30) and the user's shoulders. To achieve this, the user is required to move into a recline position. This involves the user moving the hips (24) to their second position which is representative of the limit of forwards movement of the hips (24) and leaning backwards. The user is supported in the reclined position by a wheel (86). The wheel (86) rotates when in contact with the shoulders creating body shake and shoulder twist sensations, and comprises at least one motor for imparting vibration feedback to the bodysuit (14). This is achieved through the wheel (86) being in contact with the spine (30) and the motor causing vibration feedback through the wheel (86). When in the forwards position, the wheel (86) provides realism for driving and racing games by way of the wheel (86) being directly driven by the motor(s) to simulate impacts and rough terrain.

The force feedback attachment (84) may comprise a front part (84a) that mounts the wheel (86) and associated motor and a rear part (84b) that pivotally connects to the front part (84a) and is rotatable around the support member (16). The rear part (84b) comprises a generally triangular shaped frame having first and second side members (84c) that may be referred to as “slam skirts”. The slam skirts provide a stop to limit the pivotal motion of the front part (84a) relative to the second part (84b). The pivotal connectional between the front part (84a) and the second part (84b) may comprise a ball and socket or conventional pin and socket connection. A motor may be provided to drive pivotal motion of the front part (84a) relative to the second part (84b). Impact of the front part (84a) with the slam skirts (84c) of the second part (84b) provides a realistic simulation of impact of a vehicle crashing into in content object, for example. The pivoting end of the force feedback support is to create the sensation of ‘drift’ whilst driving. This is when the rear wheels slide out when taking a corner too fast. In this instance, the sensation is created by the user slightly changing their relationship position to the wheel and pedals section.

Embodiments of the invention may comprise one or more transducer vibration speakers attached to or embedded in components of the body suit (14) and/or force feedback attachment (84). A transducer vibration speaker may be positioned on or within the pelvis (22) to provide a sense of realism to simulate experiences such as riding a motorbike or horse. In some embodiments, a transducer vibration speaker may be positioned in or on the headrest to simulate experiences such as explosions.

FIG. 9C shows a locking mechanism (88) for securing the force feedback attachment (84) in each of the first and second positions described above. The anchor (34) further comprises a base plate (90) and a pair of side plates (92) that project upwardly from the base plate (90). Together the base plate (90) and side plates (92) define a box frame. The connection members (38), described above, are positioned within the box frame between the side plates (92) and bolted thereto in a manner that allows each connection member (38) to rotate relative to the side plates, as described in more detail above. One of the side plates (92) comprises a pair of cut-outs (94). The base plate (90) also comprises a pair of cut-outs (96), the purpose of which will be described in more detail below. A plate (98) is fixed to the top of the support member (16). The plate (98) mounts a pin, spigot, or other projection (100) that projects upwardly from the plate (98).

The anchor (34) is fixed to a central tube (102) that passes through the support member (16) from the base (12). The central tube (102) provides a conduit for cables, tubes etc from the base (12) to motors, brakes, actuators etc of the bodysuit (14). The anchor (34) rotates with the central tube (102) relative to the support member (16). Rotation of the anchor is permitted between a first position and a second position by the projection (100) engaging an end of a respective channel defined by each of the pair of cut-outs (96) in the base plate (90). The pair of cut-outs (94) in the side plate (92) and the pair of cut-outs (96) in the base plate (90) permit the anchor (34) to be rotated 180 degrees relative to the support member (16) until the projection (98) engages the end of the respective channel defined by the cut-out (96) in the base plate (90).

The orientation of the anchor (34) relative to the support member (16) may be locked by a spring plate (104). The spring plate (104) comprises a first engagement portion (106) and a second engagement portion (108). The spring plate (104) is slideable forwards and backwards. Depending on the orientation of the anchor (34), either the first engagement portion (106) or second engagement portion (108) engages the projection (100) to prevent further rotation of the anchor (34) relative to the support member (16). The spring plate (104) is actuatable by way of a user pulling on a handle portion (110) of the spring plate (104). The force applied by the user needs to be sufficient to overcome the resistance provided by a spring. When the user releases the handle portion (110), the spring plate (104) is biased to slide forwards and engage the projection (100) by way of the first or second engagement portion (106, 108), depending on the orientation of the anchor (34).

The support member (16) comprises a pair of mounting brackets (112) orientated longitudinally and welded along the length of the outer surface of the support member (16). The mounting brackets (112) each mount a side member of the rear part (84b) of the force feedback attachment (84). As described above, in normal use, the anchor (34) (and consequently the bodysuit (14)) is able to rotate with the support member (16) when the spring plate (104) engages the projection (100) to lock rotation of the anchor relative to the force feedback attachment (84). When the spring plate (104) is disengaged from the projection (100), the anchor (34) (and consequently the bodysuit (14)) is permitted to rotate through 180 degrees relative to the support member (16) and force feedback attachment (84). This means that the bodysuit (14) can be rotated through 180 degrees to position the force feedback attachment (84) either in front of or behind the bodysuit (14). The bodysuit (14) is then locked in position when the spring plate (104) engages the projection (100).

The apparatus is controllable by a control system (200). The control system (200) exchanges data with a computer-generated reality (204) through a processor (202). The processor (202) collects data from a plurality of sensors (206) that record movement and other parameters of the body suit (14). The data from the sensors (206) is transmitted to the computer-generated reality (204) and translated into digital motion in the computer-generated reality (204). The processor (202) also receives data from the computer-generated reality (204) that is representative of digital motion in the computer-generated reality (204) and interaction with objects and the environment represented in the computer-generated reality (204). The data received from the computer-generated reality is translated into feedback to be imparted to the body suit (14) by way of one or more actuators. As described above, the body suit (14) comprises a plurality of motors and braking devices that provide this feedback.

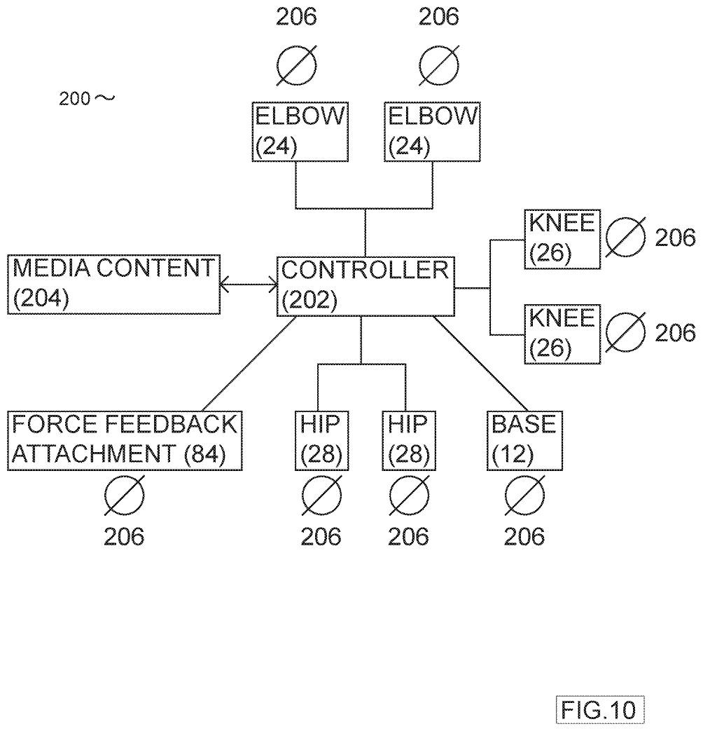

In one example, as shown in FIG. 10, the controller (202) may be a programmable logic board that comprises non-volatile memory for storing executable instructions, at least one input, at least one output and a processor. The controller (202) is connected to a power supply and handles distribution of power to each of the motors, brake servos and potentiometers. The controller communicates with a media device that is generating for display virtual reality content. In one example, the input and output are combined and take the form of a USB or USB-C data transfer port. The controller (202) also comprises a time function for tracking and synchronizing communications between the apparatus (10) and the media device. The controller (202) performs at least the following actions:
i) Controlling actuation of motors and brake servos.
ii) Receiving measurements from position sensors and potentiometers.
iii) Transferring data between the apparatus (10) and media device.
iv) Limiting movement of knee, elbow and hip joints between pre-determined safe limits.
v) Filtering noise from received measurements.

As shown in FIG. 10, the controller (200) receives an input from the media device at step (S1001). The input is representative of one or more movements of an in-game character. The movements of the in-game character are mapped at step (S1002) to one or more joints of the body suit (14). A potentiometer value of the intended movement for a specific joint is retrieved from a database at step (S1003) and compared to a permissible range of potentiometer values for the joint at step (S1004). If the potentiometer value of the intended movement for the specific joint lies within the permissible range of potentiometer values, a motor is instructed at step (S1005a) to drive the joint to the intended position. At step (S1005b), if the potentiometer value of the intended movement for the specific joint lies outside of the permissible range of potentiometer values, the controller (200) either instructs the motor to drive the joint to a third position that is associated with a potentiometer value that lies within the permissible range of potential values, or no action is taken by the controller (200). Furthermore, for motor driven joints, the permissible range of motion of such joints is limited by a physical stop to prevent a user's joint being moved into a position that could be expected to cause injury to a user having an average range of motion.

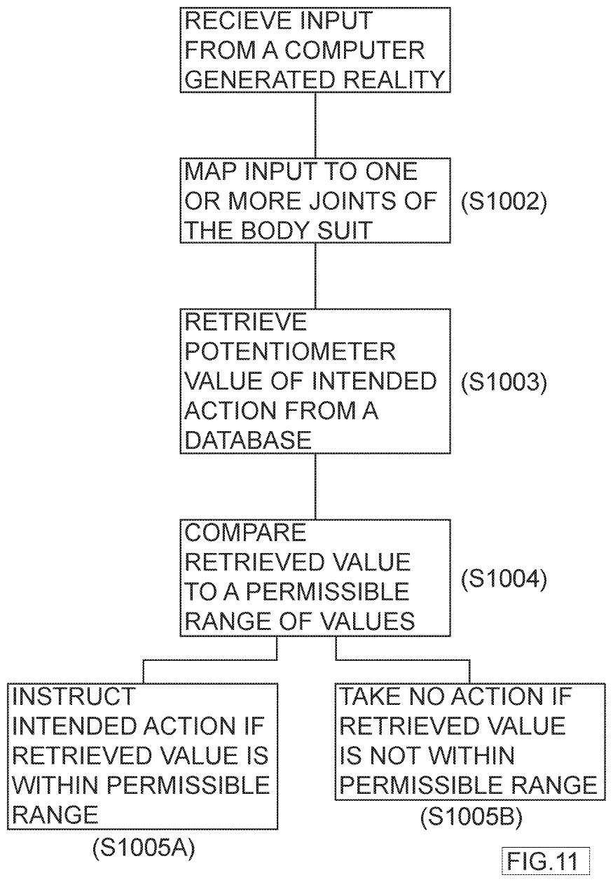

Similarly, as shown in FIG. 11, the controller (200) continually monitors a torque measurement of each joint at step (S1101). At step (S1102), the torque measurements are compared against reference values in a database of torque values for each joint. The torque value of each joint is measured using a load cell associated with each respective joint. At step (S1103a), the controller cuts power to a joint if the measured torque value exceeds an associated reference torque value. At step (S1103b), the controller instructs the motor associated with the joint to move the joint to the intended position.

### Items

1. A body suit comprising a spine configured from a plurality of vertebrae in a stacked configuration, wherein each of the plurality of vertebrae is mounted on a flexible skin, and an attachment means for attaching the body suit to a user's body, wherein the spine is configured to deform in compliance with the user's movement.
2. A body suit according to item 1 further comprising a connection member between adjacent vertebrae, wherein the connection members provide resistance against compression and lateral deformation when the spine is in an upright condition and provide a hinged connection between adjacent vertebrae to facilitate forwards and backwards deformation of the spine.
3. A body suit according to item 1 or item 2, wherein each connection member is mounted on the flexible skin.
4. A body suit according to any of items 1 to 3, wherein the vertebrae at the top of the stack has a width greater than each other vertebrae in the stack, the vertebrae at the bottom of the stack has a width less than each other vertebrae in the stack, and each other vertebrae in the stack has a width that is progressively less than the vertebrae above it.
5. A body suit according to any preceding item, wherein the spine further comprises a tendon for each vertibrae passing latitudally through each of the vertebrae.
6. A body suit according to any preceding item, wherein the spine has a curvature when in an upright position.
7. A body suit according to any preceding item, wherein the flexible skin connects the spine to a torso, arms and legs of the body suit.
8. A body suit according to any preceding item, wherein the flexible skin is formed from leather.
9. A body suit according to any preceding item further comprising a headrest atop the spine configured to support the user's head.
10. A leg for a body suit, the leg comprising an upper leg part and a lower leg part connected by a knee joint, wherein the knee joint comprises a housing forming part of one of the upper or lower leg parts and a plate forming part of the other of the upper or leg parts, and wherein the knee joint is configured to restrain movement of the leg to a single degree of freedom and selectively resist movement of the lower leg part relative to the upper leg part.
11. A leg for a body suit according to item 10, wherein the housing is a brake calliper comprising a slot, and the plate is a brake disc that is received by the slot of the brake calliper, the knee joint further comprising a pair of brake pads within the brake calliper that can be selectively applied to the brake disc to resist movement of the lower leg part relative to the upper leg part.
12. A leg for a body suit according to item 10 or item 11, wherein the upper leg part comprises a first frame part for receiving the user's femur and the lower leg part comprises a second frame part for receiving the user's tibia and fibula.
13. A leg for a body suit according to item 10-12 further comprising a motor for selectively moving the lower leg part relative to the upper leg part.
14. A leg for a body suit according to any of items 10-13 wherein the leg further comprises a flexible skin at least partially surrounding the upper leg part, lower leg part and knee joint.
15. A leg for a body suit according to any of items 10-14, wherein the flexible skin does not surround an area of the knee joint that, when a user is wearing the body suit, is in the vicinity of the user's patella.
16. A leg for a body suit according to item 15, wherein the flexible skin is formed from leather.
17. A pelvis mechanism for a body suit, wherein the pelvis mechanism comprises an anchor and a floating frame joined by a pair of connection members, wherein each connection member is able to pivot relative to both the anchor and floating frame such that the floating frame is moveable into a plurality of positions relative to the anchor.
18. A pelvis mechanism for a body suit according to item 17, wherein each connection member comprises a first stop and a second stop, wherein the first stop and second stop of a first of the pair of the connection members engage the anchor and floating frame respectively when the frame is moved forwards to a first position and the first stop and second stop of a second of the pair connection members engage the anchor and floating frame respectively when the floating frame is moved rearwards to a second position.
19. A hip for a body suit comprising an anchor positioned at opposing sides of the floating frame of items 17-18 and fixed thereto and a support member that is rotatable in a forwards and backwards motion relative to the floating frame.
20. A hip for a body suit according to item 19, further comprising a brace connecting the support member of the hip and the knee joint of items 10-16.
21. A base for a rotatable virtual reality rig comprising a fixed external base structure comprising a perimeter wall and top surface with a void defined within the perimeter wall, wherein a rotatable frame is housed within the void and is rotatable relative to the fixed external base structure, and wherein a support member extends upwardly from the fixed internal base structure and is constrained to rotate with the rotatable frame.
22. A base for a rotatable virtual reality rig according to item 21 further comprising a bottom surface and a plurality of rollers supporting the rotatable frame on the bottom surface.
23. A base for a rotatable virtual reality rig according to item 22 further comprising at least one motor configured to drive one or more of the rollers.
24. A base for a rotatable virtual reality rig according to items 21-23 further comprising a virtual reality content generation device housed within the rotatable frame.
25. An arm for a body suit comprising an upper arm part and a lower arm part connected by an elbow joint, wherein the elbow joint comprises a bearing surface that is configured to permit rotation of the lower arm part relative to the upper arm part between a first position in which the arm is fully extended, to a second arm.
26. An arm for a body suit according to item 25, wherein the bearing surface comprises a primary bearing surface defined by a projection forming part of one of the lower arm part or upper arm part and an secondary bearing surface defined by the other of the lower arm part or upper part, wherein the primary bearing surface is moveable relative to the secondary bearing surface between the first position and the second position and further movement is restrained by a first stop that engages the projection when the lower arm part is in the first position and a second stop that engages the projection when the lower arm part is in the second position.
27. An arm for a body suit according to item 25 or 26 further comprising a motor that is configured to drive the elbow joint to move the lower arm part relative to the upper arm part between the first and second positions.
28. A virtual reality rig comprising a base, a bodysuit, a support member supporting the body suit and spacing the bodysuit from the base, and a force feedback attachment, wherein the force feedback attachment is positionable either in front of or behind the bodysuit.
29. A virtual reality rig according to item 28 further comprising a locking mechanism, the locking mechanism being configured to stop rotation of the bodysuit relative to the force feedback attachment when locked, and being configured to permit rotation of the bodysuit relative to the force feedback attachment when unlocked.
30. A virtual reality rig according to item 28 or 29, wherein the support member is hollow and further comprises a central tube providing a conduit to route cables from the base to the bodysuit, wherein the central tube rotates with the support member when the locking mechanism is locked, and the central tube rotates relative to the support member when the locking mechanism is unlocked.
31. A virtual reality rig according to item 30, wherein the locking mechanism comprises a spring plate that when locked engages a projection in one of a first or second position depending on the orientation of the bodysuit relative to the force feedback attachment.
32. A virtual reality rig according to any of items 28-31 further comprising a rear part that is fixedly attached to the support member and a front part that is pivotally connected to the rear part.
33. A virtual reality rig according to item 32 further comprising at least one motor for driving the orientation of the front part of the force feedback attachment relative to the rear part of the force feedback protection.
34. A virtual reality rig according to item 33 further comprising at least one input device for providing input instructions to virtual reality content.
35. A virtual reality rig according to item 34 further comprising at least one motor for driving motion of the at least one input device and providing haptic feedback.

1. Apparatus for interaction with virtual reality content comprises a body portion configured to receive one or more parts of a user's anatomy and a base, wherein the body portion is supported by and spaced apart from the base by a support member and is configured to rotate relative to the base.

2. Apparatus according to claim 1, wherein the body portion comprises a pair of legs, each leg comprising an upper leg part and a lower leg part connected by a knee joint, wherein the knee joint comprises a housing forming part of one of the upper or lower leg parts and a plate forming part of the other of the upper or leg parts, and wherein the knee joint is configured to restrain movement of the leg to a second degree of freedom and selectively resist movement of the lower leg part relative to the upper leg part.

3. Apparatus according to claim 2, wherein the housing is a brake calliper, and the plate is a brake disc and the knee joint further comprises a pair of brake pads that can be selectively applied to resist movement of the lower leg part relative to the upper leg part.

4. Apparatus according to claim 1, further comprising a pair of arms, each arm comprising an upper arm part and a lower arm part connected by an elbow joint, wherein the elbow joint comprises a bearing surface that is configured to permit rotation of the lower arm part relative to the upper arm part between a first position in which the arm is fully extended, to a second position.

5. Apparatus according to claim 4, wherein the bearing surface comprises a primary bearing surface defined by a projection forming part of one of the lower arm part or upper arm part and a secondary bearing surface defined by the other of the lower arm part or upper part, wherein the primary bearing surface is moveable relative to the secondary bearing surface between the first position and the second position and further movement is restrained by a first stop that engages the projection when the lower arm part is in the first position and a second stop that engages the projection when the lower arm part is in the second position.

6. Apparatus according to claim 5 further comprising a motor that is configured to drive the elbow joint to move the lower arm part relative to the upper arm part between the first and second positions.

7. Apparatus according to claim 6 further comprising a spine configured from a plurality of vertebrae, wherein each of the plurality of vertebrae is mounted on a flexible skin, and an attachment means for attaching the body suit to a user's body, wherein the spine is configured to deform in compliance with the user's movement.

8. Apparatus according to claim 7 further comprising a connection member between adjacent vertebrae, wherein the connection members provide resistance against compression and lateral deformation when the spine is in an upright condition and provide a hinged connection between adjacent vertebrae to facilitate forwards and backwards deformation of the spine.

9. Apparatus according to claim 7, wherein the vertebrae at the top of the stack has a width greater than each other vertebrae in the stack, the vertebrae at the bottom of the stack has a width less than each other vertebrae in the stack, and each other vertebrae in the stack has a width that is progressively less than the vertebrae above it.

10. Apparatus according to claim 7, wherein the spine further comprises a pair of tendons passing longitudinally through each of the vertebrae.

11. Apparatus according to 2, further comprising a pelvis mechanism joining the torso to the legs, wherein the pelvis mechanism comprises an anchor and a floating frame joined by a pair of connection members, wherein each connection member is able to pivot relative to both the anchor and floating frame such that the floating frame is moveable into a plurality of positions relative to the anchor.

12. Apparatus according to claim 11, wherein each connection member comprises a first stop and a second stop, wherein the first stop and second stop of a first of the pair of the connection members engage the anchor and floating frame respectively when the frame is moved forwards to a first position and the first stop and second stop of a second of the pair connection members engage the anchor and floating frame respectively when the floating frame is moved rearwards to a second position.

13. Apparatus according to claim 11 further comprising a pair of hips, each hip comprising an anchor positioned at opposing sides of the floating frame and fixed thereto and a support member that is moveable in a forwards and backwards motion relative to the floating frame.

14. Apparatus according to claim 13 further comprising a brace connecting the support member of the hip and the knee.

15. Apparatus according to claim 1 further comprising a force feedback attachment that is moveable between a first position behind the body suit and a second position in front of the body suit, wherein the force feedback protection is configured to impart vibration feedback into the body suit when in the first position and to be used as input device for video game content when in the second position.

16. Apparatus according to claim 13, wherein the input device of the force feedback attachment comprises a control device for controlling objects within video game content.

17. Apparatus according to claim 15 further comprising a controller for: i) receiving an output from video game content and actuating one or more of the knee, elbow, hip or force feedback attachment in correlation with an action from within the video content; and ii) determining a position, motion, or other action of one or more of the knee, elbow, hip or force feedback attachment and instruction an object from within the video game content to take a pre-determined action.

18. Apparatus according to claim 17, wherein the controller is configured to:
a. receive an input from a media device representative of an instruction to move a knee joint, elbow joint or hip from a first position to a second position;
b. retrieve from a database a potentiometer value for the second position;
c. compare the potentiometer value for the second position with a range of safe potentiometer values;
d. if the potentiometer value for the second position lies within the range of safe potentiometer values, instruct a motor to move the knee joint, elbow joint or hip from the first position to the second position; and
e. if the potentiometer value for the second position is outside of the range of safe potentiomer values, either instruct a motor to move the knee joint, elbow joint or hip to a third position that corresponds to a potentiometer value that lies within the range of safe potentiometer values, or take no action.

19. Apparatus according to claim 13, wherein the body suit is selectively moveable between a reclined position in which the user rotates the hip of the body suit backwards to a first position and a face down position in which the user rotates the hip of the body suit forwards to a second position.

20. Apparatus according to claim 19 wherein movement of the body suit between the first position and the second position is driven by a motor operated by controller and the body suit can be selectively moved to an intermediate position between the first position and the second position.

21. (canceled)

22. (canceled)

23. (canceled)

24. (canceled)

25. (canceled)
